(19) United States
(12) Patent Application Publication
(10) Pub. No.: US 2016/0162841 A1
(43) Pub. Date: Jun. 9, 2016

(54) METHOD AND SYSTEM FOR CONNECTING PEOPLE AND EMPLOYERS BASED ON WORKPLACE CULTURAL PREFERENCE

(71) Applicant: CulturecliQ LLC, Livonia, MI (US)

(72) Inventors: Colleen Albright, Livonia, MI (US); Joseph Walker, Bingham Farms, MI (US); Matthew S. Chartier, Shelby Township, MI (US); Suzanne Z. Chartier, Shelby Township, MI (US); Dmitriy Kostyuchenko, Lewisburg, TN (US)

(21) Appl. No.: 14/964,102

(22) Filed: Dec. 9, 2015

Related U.S. Application Data
(60) Provisional application No. 62/089,714, filed on Dec. 9, 2014.

(51) Int. Cl. G06Q 10/10

(52) U.S. Cl. CPC G06Q 10/1053

(57) ABSTRACT

A web-based matching system for potential candidates to be matched with employers based in part on the cultural similarities between the working environment and the candidate's nature. Candidates and employers are required to answer questions designed to quantify their cultural bent. A Matching Algorithm calculates matches as a function of the quantified cultural preferences. When the calculated match rate exceeds the threshold, the filtered results are depicted on an annular radar diagram and arranged with the highest match rates closest to the diagram center. The system automatically generates affinity groups based on the unique answer combinations to the cultural questions. Both candidates and employers are placed in sufficiently matching affinity groups to facilitate networking. Connections may be provided to the candidate and employer pre-existing social media accounts.

### CROSS REFERENCE TO RELATED APPLICATIONS

This application claims priority to Provisional Patent Application No. 62/089,714 filed Dec. 9, 2014, the entire disclosure of which is hereby incorporated by reference and relied upon.

### BACKGROUND OF THE INVENTION

1. Field of the Invention

This invention relates generally to a business method or system for recruiting worker talent, and more specifically to a web-based matching system or meeting place for potential candidates to be matched with employers sharing a common cultural bent.

2. Description of Related Art

The term “recruiting talent” refers to a desire for a process of hiring the right people for the right position (“right fit”). When an employer needs a person to fill a job vacancy with certain skill sets, the employer may enlist the help of a recruiting service or firm. In so doing, the employer submits a job description to the recruiting service detailing the specific needs of the company and providing some general information about the company itself. Likewise, a person seeking employment (i.e., a candidate) may also enlist the help of the recruiting service or firm. The candidate submits a résumé or curriculum vitae (“CV”) describing themselves and the type of employment they are seeking. In both cases, the recruiting service or firm carefully analyzes and refines the employer job description and the candidate résumé or CV. The manager then attempts to match the person to a job and the employer to a person. Recruiting services and firms presently exist via websites, head hunters, staffing and recruiting firms and job search agencies, including executive search, campus recruitment offices, and the like. Recruiting services and firms tend to be expensive, and therefore more and more employers and prospective candidates are turning to mass online recruiting systems.

Online recruiting systems include self-directed recruitment websites and social networking platforms. Self-directed recruitment websites (like Monster.com, for example) typically have two main features: 1) job boards, and 2) a résumé or CV database. Job boards allow a membered employer to post job vacancies. Candidates can filter and find what they are looking for in the listings of jobs posted by employers. With regard to the CV database, people seeking employment upload their CVs to be included in searches by membered employers. The recruitment websites capture all of the data concerning prospective candidates' skills and then pool the data for the membered employers in an accessible interface. Social networking platforms, on the other hand, use social media for connecting employers to prospective candidates and vice versa. Social networking platforms include, for example, Facebook, Twitter, Google+, and LinkedIn. Social networking platforms can directly connect candidates and employers, but are relatively inefficient vehicles for filling job vacancies and finding jobs.

The prior art has taught many different techniques and systems for efficiently matching employers with “right fit” talent. And yet, none have been able to successfully overcome the persistent shortcomings associated with high employee turn-over rates and laborious review of job applicants. For example, Canadian Patent No. CA 2,277,261, issued Jan. 9, 2001 in the name of Sign et al., discloses a computer system and process for matching one or more candidates with an employment position of an employer. This system allows a recruiter to search a database using a complex series of algorithms in an attempt to find qualified candidates based on multiple parameters and to match candidate profiles with a company's needs. In this patent, an assessment tool is described that is used to evaluate certain qualitative factors such as whether the candidate will fit the specific employer culture of the company. Singh et al. generates this qualitative information on the candidate side, but this information is not matched with anything on the employer side other than a subjective evaluation on the part of the recruiter. As a result, Singh et al. is ineffective to address the issue of laborious review of job applicants imposed on employers.

In another example, US Patent Publication No. 2008/0147630, published Jun. 19, 2008 in the name of Chu, describes a system for generating job recommendations for candidates and companies. This patent describes a matching algorithm (e.g., Euclidean algorithm) that is used to calculate a match degree between a particular job and a particular candidate. One of the job matching methods includes a personality match that is classified as ten categories: creative, detail-oriented, expressive, leadership, multi-tasks management, patient, risk taker, sociable, and self-motivated. Chu, therefore, uses its matching algorithm to match a candidate with a particular job posting. As a result, Chu is ineffective to address the issue of high employee turn-over rates and overall job satisfaction on the part of the candidate.

All forms of the current online recruiting systems have been found to exhibit certain shortcomings. These shortcomings include the mere presentation of lists of candidate résumés or CV' s and vacancies in employers. Persons seeking employment are required to search vacancies posted by employers and tediously review the required skills for each posting. Employers are also burdened with the laborious review of large volumes of non-standard prospective candidate's CV's to find those well-qualified for the positions needing to be filled. Moreover, these systems do not consider qualitative ways to depict candidate and employer characters, which over time leads to employee retention problems and job dissatisfaction. Thus, there are needs in both methodology and systems to match what employers are looking for and what employees are seeking qualitatively.

### BRIEF SUMMARY OF THE INVENTION

The present invention contemplates a computer-assisted method for connecting candidates and employers. The method comprising the steps of establishing a candidate account associated with a candidate and an employer account associated with an employer. The candidate adds candidate qualitative data and candidate cultural data to their electronic candidate profile. Similarly, the employer adds employer qualitative data and employer cultural data to their electronic employer profile. For each user, the step of adding cultural data to their profile includes recording answers to a defined set of cultural questions, wherein a scale value is ascribed to each of a plurality of unique cultural descriptors. The completed profiles for candidates are submitted to a candidate database, and the completed profiles for employers are submitted to an employer database. A candidate initiates a search query from their candidate account to the employer database, or vice-versa in the case of the employer initiating a search. The full results of the search query are generated but not displayed to the requesting party. Before the requesting party can view the search results, a Matching Algorithm is applied to the search results. The Matching Algorithm is operatively connected to the candidate database and the employer database. The Matching Algorithm calculates a secondary match rate as a function of the numerical weights associated with the scale values ascribed to the respective candidate cultural descriptors and the employer cultural descriptors. Thereafter, the match rate produced by the Matching Algorithm is displayed through a graphic user interface to the requesting party but only if the match rate exceeds a predetermined threshold value.

The system is particularly efficient for employers seeking to recruit talent and for candidates seeking employment. In each case, the requesting party is presented with qualified leads who are matched in terms of culture, matched in terms of benefit structure/expectations, matched in terms of geographical proximity and matched in terms of job needs. The cultural match is found to be a particularly compelling attribute given the high employee turn-over rates in many industries. Cultural matching is found to provide a more efficient and more reliable indicator of employee retention and overall job satisfaction. As a consequence, the present invention represents a substantially less burdensome technique and methodology with which to review large pools of job-seeking candidates to find those not only best-qualified for the positions needing to be filled, but just as importantly those best-suited to the culture of the particular workplace. Furthermore, the method and system of this invention enable the collection of unique data regarding the cultural make-ups of both candidates and companies. Knowledge about cultural preferences is potentially very valuable information that has remained largely untapped due to ineffective data collection tools. The present invention is particularly adapted to mine data about what candidates consider to be important in a workplace environment, and similarly data as to how employers describe themselves. These and other culturally-informed data sets can be gathered for useful purposes by this invention. For example, is there a particular data set that arises from engineers, or programmers. Do accounting firms and law firms have a similar culturally profiles? These and many more valuable insights are enabled by the principles of this invention.

### BRIEF DESCRIPTION OF THE SEVERAL VIEWS OF THE DRAWINGS

These and other features and advantages of the present invention will become more readily appreciated when considered in connection with the following detailed description and appended drawings, wherein:

FIG. 1 is a simplified diagram illustrating three candidates and three employers who all share a common cultural affinity and who are all associated with one another in a common affinity group;

FIG. 2 is a diagrammatic overview of the method and system of the present invention in which potential candidates are matched to employers based in significant part on the nature of the employer's culture and the working environment a candidate seeks;

FIG. 3 is a more detailed diagrammatic view as in FIG. 2 but focusing on the candidate portion of the method and system;

FIG. 4 is an illustrative view of a candidate interfacing with their profile via an on-line connection to the candidate server, and showing an enlarged take-off of the Graphic User Interface as the candidate answers the candidate cultural questions;

FIG. 5 is a detailed diagrammatic view as in FIG. 2 but focusing on the employer portion of the method and system;

FIG. 6 is an illustrative view of an employer interfacing with their profile via an on-line connection to the employer server, and showing an enlarged take-off of their Graphic User Interface as the employer answers the employer cultural questions;

FIG. 7 is a highly simplified diagrammatic view of the Matching Algorithm according to one exemplary embodiment of the invention; and

FIG. 8 is a depiction of a radar diagram used by one exemplary embodiment of the present invention to report the results of matches and as a central interface tool through which the user accesses all features and functions offered through the system.

### DETAILED DESCRIPTION OF THE INVENTION

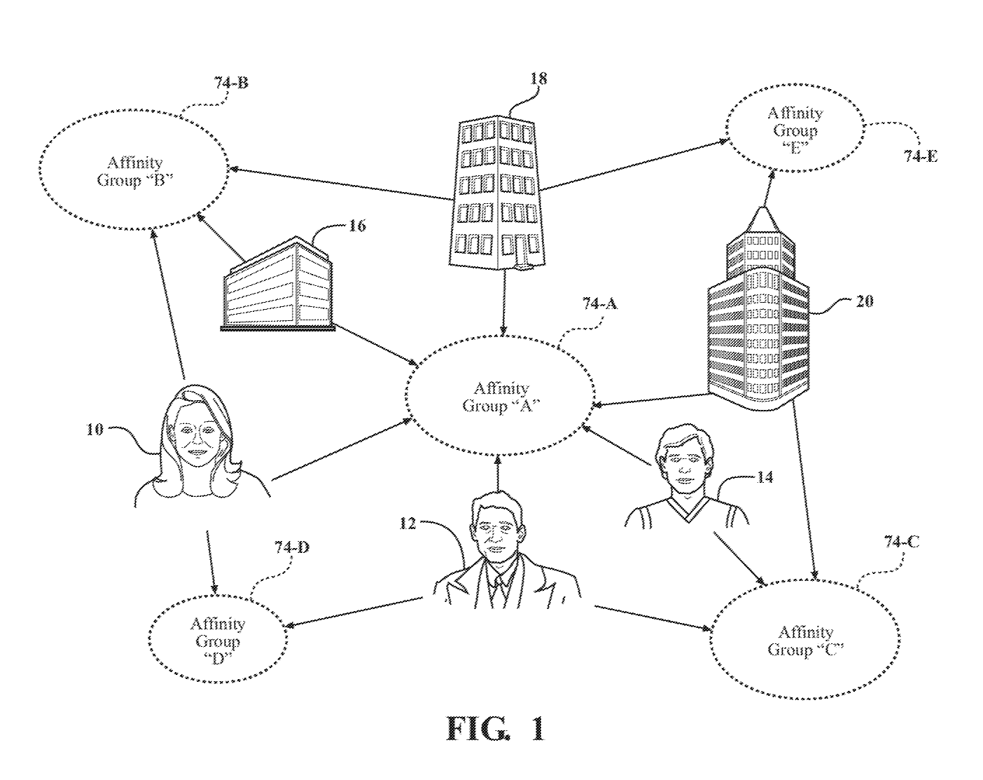

Referring to the figures, wherein like numerals indicate like or corresponding parts throughout the several views, this invention contemplates a computer-assisted method and a system for connecting candidates with employers, and candidates with other candidates, and employers with other employers. This the illustrative example of FIG. 1, three candidates are shown at 10, 12, 14, respectively. And three employers are shown at 16, 18, 20, respectively. It will be understood that the system and methods of this invention contemplate the participation of large numbers of candidates and large numbers of employers, yet only three of each are shown in FIG. 1. Only one candidate 10 and one employer 16 are shown in several of the other figures. Needless to say, these are merely representations to facilitate discussion of the concepts of this invention. Furthermore, the terms “candidate” and “employer” are used in the broadest possible sense to refer to any type of individual and/or organization that might find usefulness in the principles of this invention. For example, this invention could be used to connect volunteers with community service organizations, to connect groups or associations with supporters, to connect churches with parishioners, to connect employed persons to various departments or divisions within the context of an umbrella/parent organization, to connect suppliers/vendors with customers, and candidate to candidate to name but a few of the contemplated alternative applications. Nevertheless, the invention is perhaps most easily understood within the context of connecting both active and passive job-seeking candidates with employers. Thus, in the example of FIG. 1, three job-seeking candidates 10, 12, 14 and three employers seeking to fill job vacancies 16, 18, 20 are simultaneously engaged with the present invention.

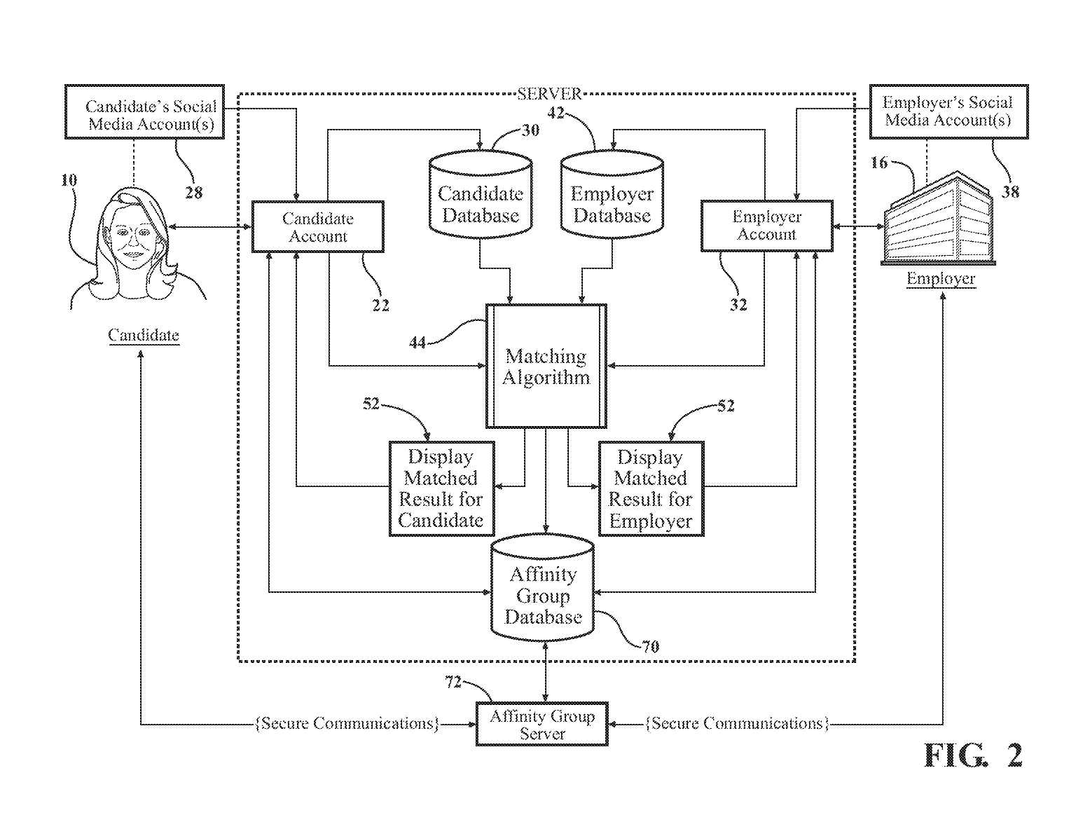

Turning now to FIGS. 2-4, the candidate-specific aspects and interactions will be considered in detail. Later, discussion will turn to the employer-specific aspects of the present invention. At the outset, each candidate (referring illustratively only to candidate 10 in FIGS. 2-4) establishes their own personal, private candidate account 22. The candidate account 22 is, naturally, associated with the candidate 10 and is, preferably, accessed through a password protected on-line computer application. The candidate account 22 contains an electronic candidate profile 24, in which personal details about the candidate 10 are recorded. Both candidate qualitative data and candidate cultural data are added by the candidate 10 to their electronic candidate profile 24. Candidate qualitative data may include personal contact information (e.g., name, telephone number, email address, etc.), geographic location data (e.g., home address), and aptitude examples (e.g., certifications, accomplishments, etc.), working experience examples (e.g., current and previous employers), personal social media account information (e.g., Facebook or LinkedIn), personal reference information (e.g., names of people to contact), and the like. Some or all of these types of qualitative data are added into the electronic candidate profile 24, usually by the candidate 10, in an attempt to expose his or her basic identity traits of “Who I am” and “What I Do Well.”

An altogether different aspect to the candidate 10 might be “What is Important to Me,” or “To What Do I Aspire in a Working Environment.” To reveal this dimension of the candidate 10, candidate cultural data is added to the candidate profile 24. Candidate cultural data is obtained by requiring the candidate 10 to answer a defined set of candidate cultural questions 26. According to one exemplary embodiment of this invention, the defined set of candidate cultural questions comprises the following thirty descriptors or cues:

A Learning Environment. This descriptor refers to a desire for continuous improvement and a quest for lifelong learning.

Laid-back. This descriptor refers to a desire for a relaxed, easy going and casual working environment.

Creative. This descriptor refers to a desire for a working environment in which original, artistic or imaginative work is valued.

Rewarding. This descriptor reflects a desire for a working environment in which accomplishments are recognized and the work has purpose and meaning.

Global. This descriptor queries to what degree a candidate desires a workplace where there exist opportunities for international interaction or foreign assignments.

Results Driven. This descriptor refers to a desire for a working environment in which there is a strong focus on meeting goals and objectives. Ambition is encouraged and are results rewarded in a “Results Driven” workplace culture.

Collaborative. This descriptor refers to a desire to work in a place where all people are empowered and encouraged to work with others.

Technical. This descriptor refers to a working environment where information technology is a focus. In a “Technical” workplace, technical acumen and technical approaches are valued.

Academic. This descriptor refers to a desire for scientific and educational elements to be prominent in the working environment. A premium is placed on knowledge and logic in an “Academic” workplace.

Competent. This descriptor refers to a desire to be a part of a capable, experienced, skilled and proficient workforce. Employees in a “Competent” workplace are proud to work with one another.

Community Focused. This descriptor reflects a desire to work for a company that regularly gives back to the community.

Individualistic. This descriptor refers to a working environment where work is accomplished by individuals who primarily work alone.

Social. This descriptor refers to a desire for working in a friendly environment. A “Social” company acts as a community both inside and outside the workplace.

Hip. This descriptor refers to a desire for a work culture that is very cool and on the cutting edge.

Engaged. This descriptor refers to a desire for the workplace to regularly exhibit a high level of productive activity. In an “Engaged” business, employees are passionate and committed to the company.

Team Oriented. This descriptor refers to a desire for results accomplished through high-performing teams. Employees in a “Team Oriented” culture put the interests of the team ahead of their own.

Work Life Balance. This descriptor refers to a desire for a family friendly culture at work. A “Work Life Balance” workplace recognizes the need to live a balanced life.

Accountable. This descriptor refers to a desire for a workplace where people are answerable to themselves and to others. In an “Accountable” culture, employees are given responsibility and held responsible for their actions. Both efforts and results matter.

Empowered. This descriptor refers to a desire for working culture where employees are given both the tools and the resources and the authority to do their jobs.

Cautious. This descriptor refers to a desire for an atmosphere that requires thoughtful and alert actions.

Innovative. This descriptor refers to a desire for a workplace culture that is inventive, resourceful and/or pioneering.

Professional. This descriptor refers to a candidate's desire for a corporate environment such as a law, accounting or a medical office.

Flexible. This descriptor refers to a desire for a workplace culture that displays a willingness to adapt. A “Flexible” company changes quickly when needed.

Positive. This descriptor refers to a desire for a working environment that is optimistic and upbeat. In a “Positive” company, a good attitude is everything.

Risk taking. This descriptor refers to a candidate that desires to work in a culture where intelligent risks propel the company forward.

Wellness Oriented. This descriptor refers to a desire to work in a culture where concern for the employees' health is a prime concern. A “Wellness Oriented” company fosters attentiveness to fitness and nutrition for its employees.

Growth Oriented. This descriptor refers to a desire for a workplace whose focus is on a profitable future.

Travel Free. This descriptor refers to a desire to work for a company that does not require or expect its employees to travel.

Challenging. This descriptor refers to a desire for a workplace culture that stretches its employees every day. A “Challenging” company provides an environment that thrives on fast-paced, last-minute situations.

Bold. This descriptor refers to a desire to work in a company that moves on the market quickly. A “Bold” company takes risks and does what most other companies would not.

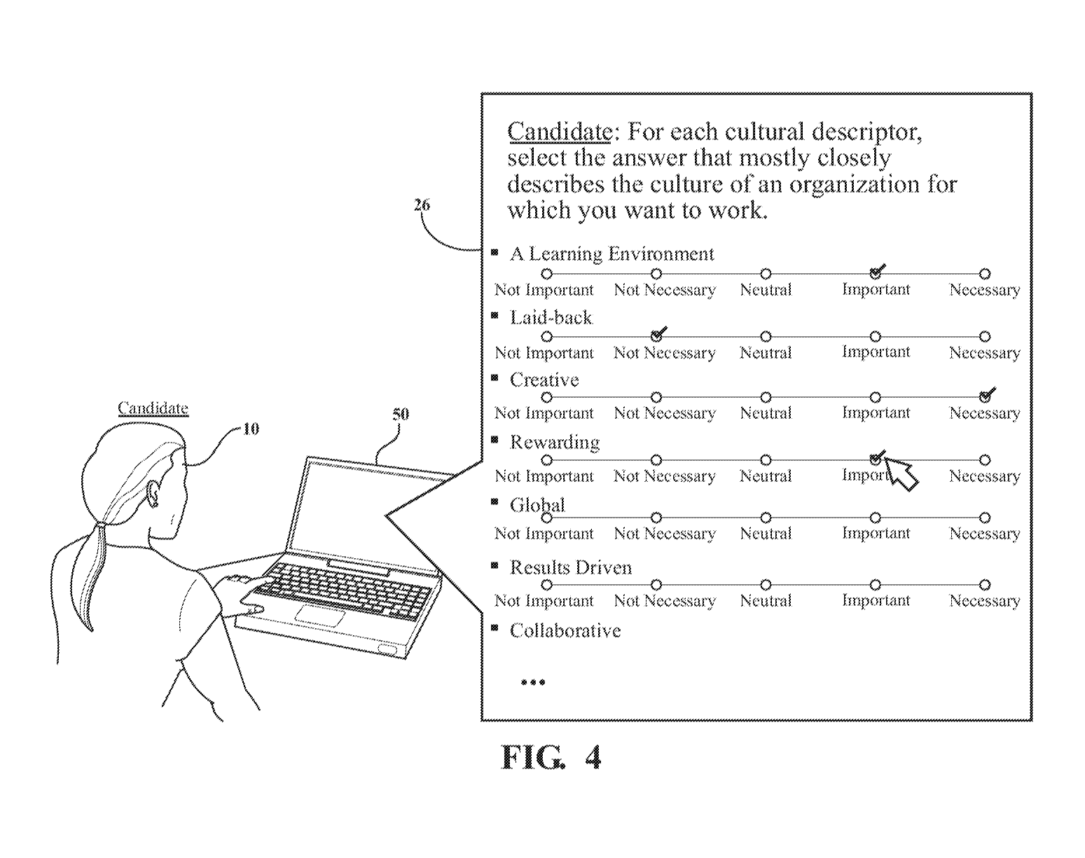

The system requires that the candidate 10 answer the candidate cultural questions 26 in such a way that it is possible to ascribe a scale value to each candidate cultural descriptor indicative with the candidate's sense of like-mindedness toward that particular cue within the context of a workplace environment. (Other applications of this invention may require reference to a different context. For example, rather than the context of a workplace culture the candidate 10 may seeks a certain cultural environment within the context of a volunteer organization, etc.) The scale values should be sufficiently graduated so as to distinguish between several levels of attraction—from total rejection at one end of the spectrum, to total affirmation at the other end of the spectrum. In-between these extremes, several grades of importance should be discernable. In the example of FIG. 4, the candidate 10 is shown answering each of the candidate questions 26 by selecting from a scale value group consisting essentially of: Not Important and Not Necessary and Neutral and Important and Necessary. This represents an ascending scale of subjective importance to the candidate 10. In the illustrated Not Important is the lowest in terms of desire to the candidate 10, Not Necessary is the second lowest, Neutral is the third lowest, Important is the second highest and Necessary is the highest level of desire. A numerical weight is then associated with each scale value in ascending relation. For example, the numerical values could be ascribed thusly: Not Important=0; Not Necessary=1; Neutral=2; Important=3; Necessary=4. Or in another example, the numerical values could be ascribed: Not Important=−2; Not Necessary=−1; Neutral=0; Important=+1; Necessary=+2. The weighting need not be uniformly progressive. For example, the numerical values could be ascribed: Not Important=−5; Not Necessary=−2; Neutral=0; Important=+5; Necessary=+10. Those of skill in the art will appreciate the many alternative choices available when ascribing numerical values to the answers for each cultural descriptor, and indeed that more or less than five possible choices may be made available to the candidate 10.

Of course, other words or numbers or symbols could be used instead of the five specific words depicted in FIG. 4. For example, in an alternative embodiment the scale value group could be formulated as a simple numerical (analog) scale 0-1-2-3-4 where “0” represent the lowest in terms of desire to the candidate 10 and “4” is the highest. In this case, the candidate 10 is instructed to rank the importance of each cue by selecting one number to indicate their level of their interest in working for a business that shares a similar cultural cue. In another alternative, symbols could be used instead of words or numbers to ascribe a scale value to each candidate cultural descriptor. For instance, the Wong-Baker FACES® Pain Rating Scale is often used by medical doctors to elicit from a patient the level of bodily pain they are experiencing. The patient is shown a series of cartoon human faces arranged in a sequence. The faces are drawn so as to reflect the facial expression a person may produce when reacting to pain at six different levels. The Wong-Baker FACES® Pain Rating Scale ascribes numerical values to each face depiction as: 0-2-4-6-8-10. Of course, these are but some of the many alternative examples for words or numbers or symbols that could be used to ascribe a numerical scale value to each candidate cultural descriptor.

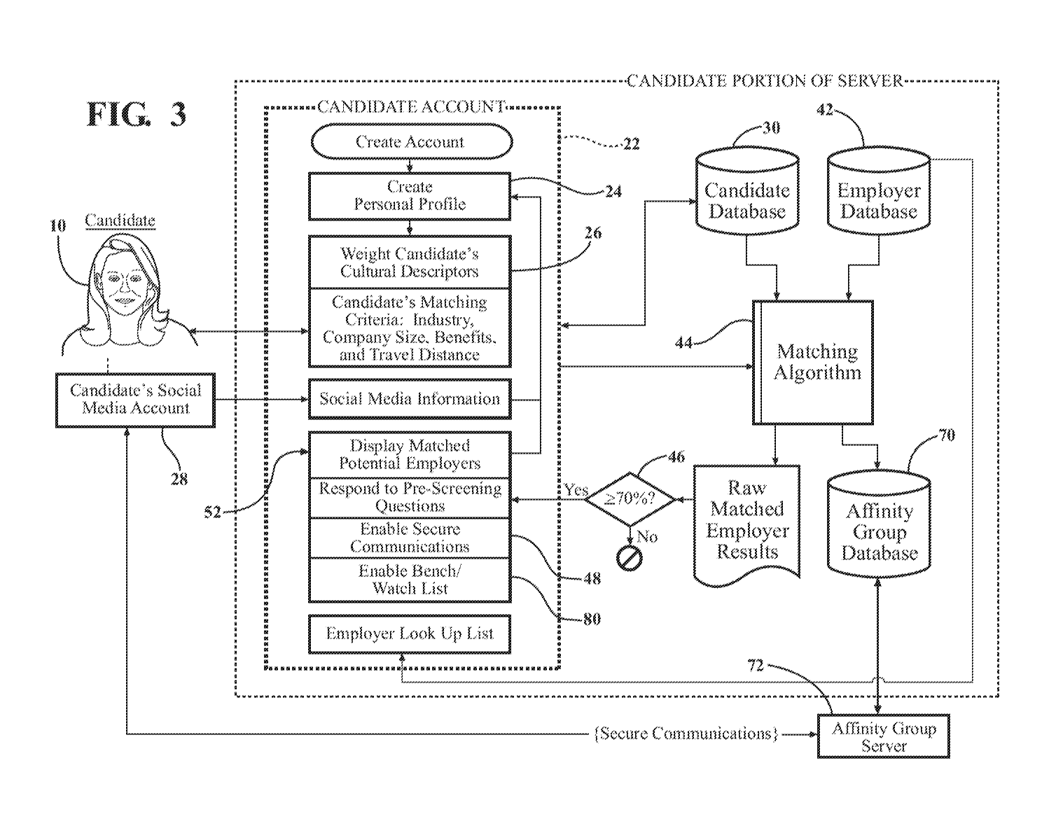

Another optional element tied to the candidate account 22 involves the candidate's social media account 28. Many people maintain at least one personal social media account 28, such as Facebook® or LinkedIn®. In the event the candidate 10 has one or more one personal social media account's 28, the system allows the candidate 10 to associate their social media account(s) 28 with their candidate profile 24, as shown in FIGS. 2 and 3. In this manner, the system leverages the various connections the candidate 10 may have already established in their pre-existing social media account(s) 28. Information contained in the social media account(s) 28 is made readily accessible through the System and included in the candidate profile 24 data for consideration by others after a sufficiently high match rate is calculated and/or by other members of a common affinity group, as will be described in detail below.

The electronic candidate profile 24 may, of course, include additional or alternative details of both the qualitative and cultural type. It is to be understood that the examples given here and illustrated in the Figures are not to be construed as limiting in any way. Once the candidate 10 has finished entering all of their personal details into their electronic candidate profile 24, the completed candidate profile 24 is submitted to a candidate database 30. The candidate database 30 may be of any suitable type including a computer readable storage medium configured to electronically store the data in the candidate profile 24. The candidate database 30 should have capacity to easily contain many tens of thousands (or more) of distinct candidate profiles, each associated with a respective candidate account. In this manner, the candidate database 30 stores all of the personal details—both qualitative and cultural—pertaining to each candidate 10 that has established a candidate account 22.

Turning now to FIGS. 2 and 5-6, the employer-specific aspects and interactions will be described. (For convenience, any employer interacting with the system will be referred to representatively as employer 16.) Each employer 16 must establish a private employer account 32. It is conceivable that large organizations may be organized with multiple hiring centers, such as in different departments or different geographic locations. In such instances, the large organization could choose to create numerous distinct employer accounts 32. The employer account 32 is, naturally, associated with the employer 16 and is, preferably, accessed through a password protected on-line computer application. The employer account 32 contains an electronic employer profile 34, in which details about the employer 16 are recorded. Both employer qualitative data and employer cultural data are added by the employer 16 to their electronic employer profile 34. Employer qualitative data may include business contact information (e.g., H.R. Director name, telephone number, email address, etc.), geographic location data (e.g., business address), operations details (e.g., work days/shifts, working conditions, etc.), industry details (e.g., healthcare or automotive), benefits structure (e.g., health plans, retirement savings, etc.), and the like. Some or all of these types of qualitative data are added into the electronic employer profile 34 to delve into the basic workplace attributes of “Who are we” and “What Do We Do.”

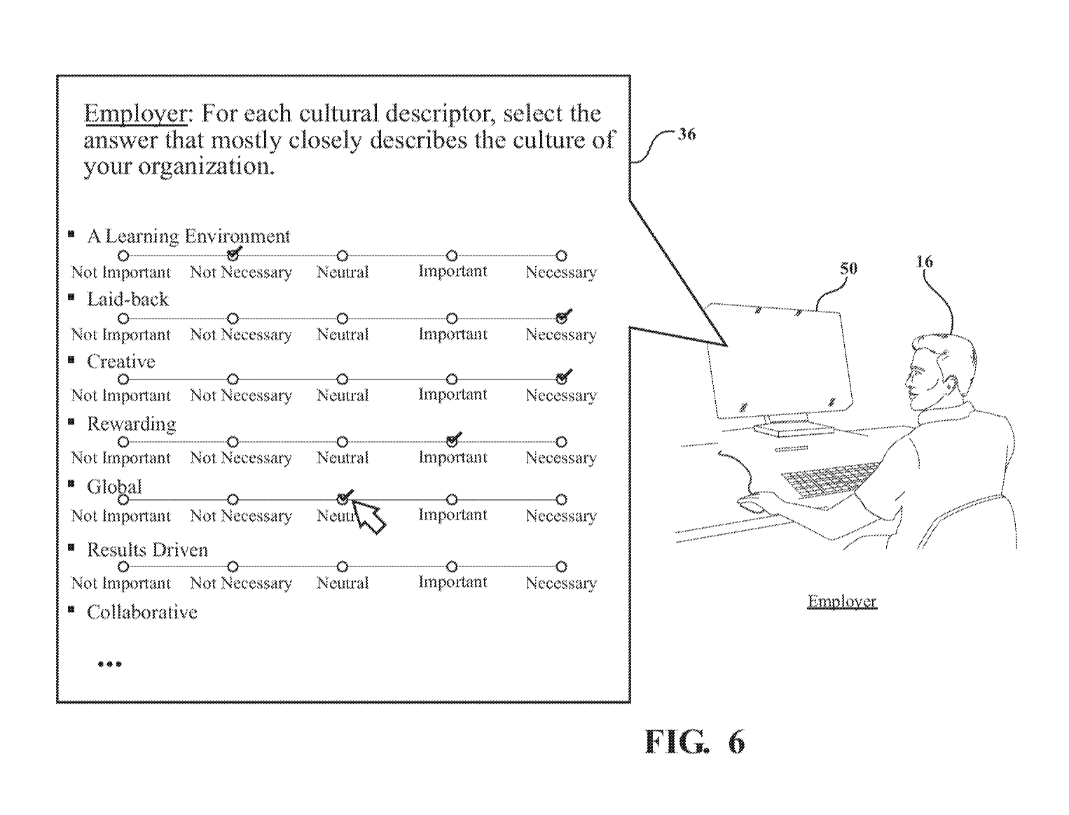

Another important aspect to the employer 16 is “What is Important to Us,” or “What Culture Do We Foster in Our Workplace.” To reveal this facet of the employer 16, employer cultural data is added to the employer profile 34. Employer cultural data is obtained by requiring the employer 16 to answer a defined set of employer cultural questions 36. The employer cultural questions 36 are the same, or at least mirror, the defined set of candidate cultural questions 26 described above. To avoid repetition, for the purposes of this example it is sufficient to assume that the employer cultural questions 36 comprise the same thirty descriptors or cues detailed above, and as also partially illustrated in FIG. 6. And also as in the candidate culture questions 26, each employer cultural descriptor within the set of employer cultural questions 36 must be ranked using a specified list or scale (e.g., Not Important-Not Necessary-Neutral-Important-Necessary) and ascribed a progressive numerical value (e.g., 0-1-2-3-4).

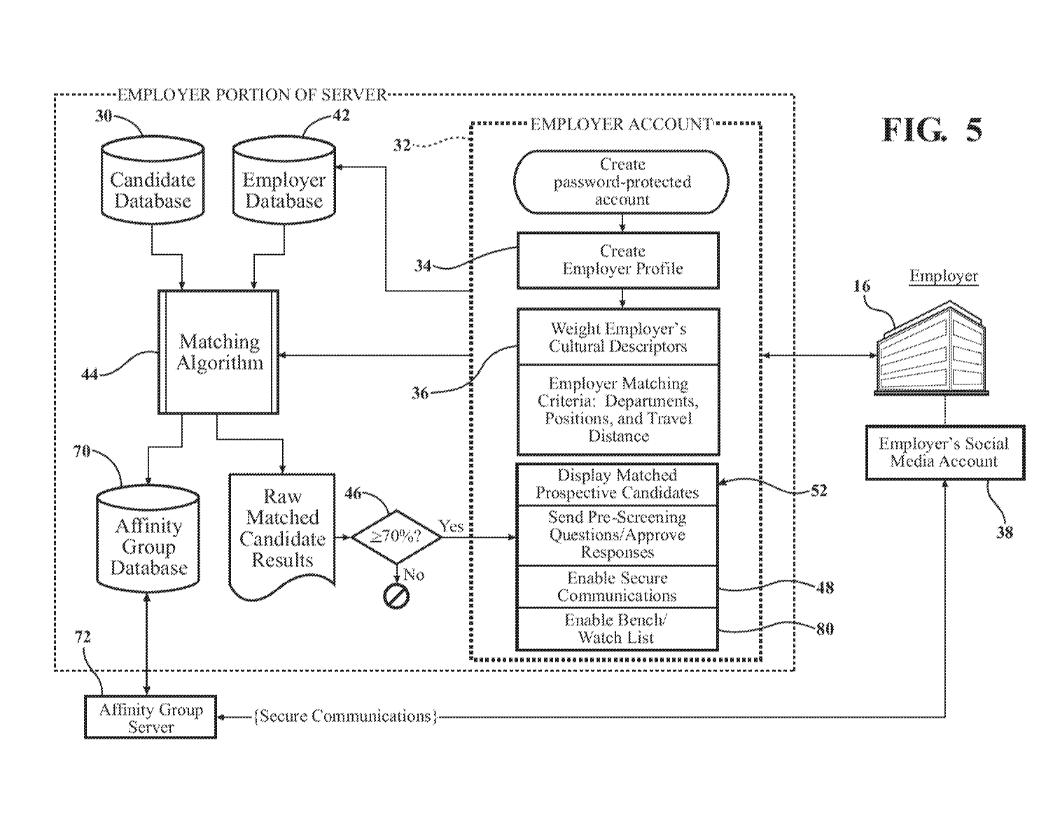

The employer's social media account(s) 38, if any, may optionally be associated with their employer account 32, as shown in FIGS. 2 and 5. As mentioned above, the system has the ability to take advantage of the various networking connections and other information the employer 16 may have established in their pre-existing social media account(s) 38. Information contained in the social media account(s) 38 is accessible through the system and included in the employer profile 34 data for consideration by certain others who have been approved through an initial vetting operation, as will be described in detail below.

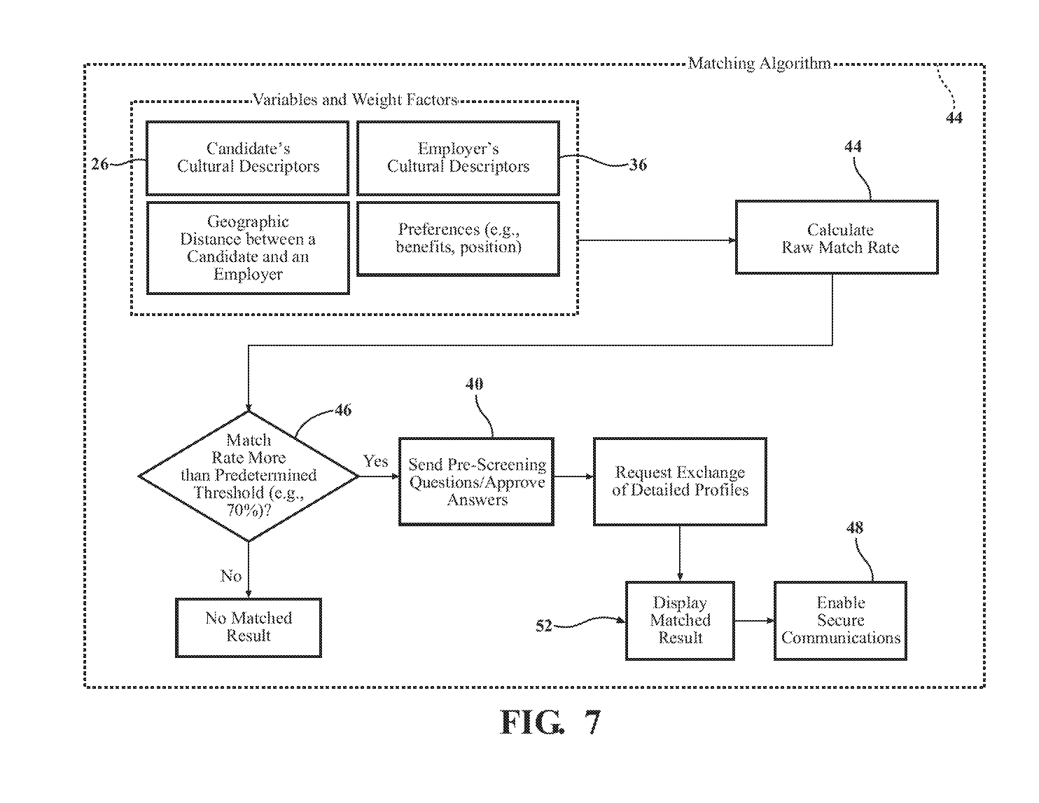

Furthermore, in completing the employer profile 34, the employer 16 establishes a set of pre-screening questions 40. See also description of the Interview button 64, below. As an example, the set may be comprised of five specific questions 40, as shown in FIG. 7. The employers 16 can define pre-screening questions 40 according to their own dictates, or by selecting from a well-cultivated list of questions like those shown below:

How many jobs have you had in the past 5 years?

Have you been terminated and/or lost your job due to restructuring from a previous employer? If so, explain?

Why are you interested in working at our company?

Why did you pursue your degree/career direction?

What was your salary for the last position you held?

What are your minimum salary requirements if you were to join our company?

How do you relieve stress?

Why would you be a good fit for our company?

What certifications do you hold?

What community activities and/or organizations do you participate in and/or belong to?

What's the best piece of constructive criticism you have ever received?

What traits and/or characteristics have made you successful in the past?

How did you find your last two positions?

What would your previous supervisor say about you and your performance—both good and bad?

Describe your ideal work culture.

Describe your ideal boss.

What are the non-negotiables you are looking for in your next position, e.g. I need a flexible work environment, etc.?

Describe how you handle conflict?

What was your favorite job and why?

Please explain any gaps in your employment history?

Please describe why you are leaving your current position and/or what caused you to leave your last position?

How does your past work experience prepare you for the position for which you are applying?

The electronic employer profile 34 may, of course, include additional or alternative details of both the qualitative and cultural type. It is to be understood that the examples given here and illustrated in the Figures are not to be construed as limiting in any way. Once the employer 16 has finished entering all of their business details into their electronic employer profile 34, the completed employer profile 34 is submitted to an employer database 42. Like the candidate database 30 described earlier, the employer database 42 may be of any suitable type including a computer readable storage medium configured to electronically store the data captured in each employer profile 34. The employer database 42 should have capacity for many tens of thousands (or more) of distinct employer profiles, each associated with a respective employer account 32. In this manner, the employer database 42 stores all of the company details—both qualitative and cultural—pertaining to each employer 16 who maintains an employer account 32.

The method and system of this invention are coded with instructions and specifically configured to execute a Matching Algorithm 44, which is operatively connected to the candidate database 30 and also to the employer database 42, as perhaps best shown in FIG. 2. As its name implies, the purpose of the Matching Algorithm 44 is to match-up candidates 10 with like-minded employers 16, and vice-versa. The Matching Algorithm 44 calculates a match rate as a function of the numerical weights associated with the scale values ascribed to the respective candidate cultural descriptors and the employer cultural descriptors. Using the weighted values ascribed to the answers given for the candidate 26 and employer 36 cultural questions, the Matching Algorithm 44 computes the Euclidean distance in n-dimensional space between each candidate 10 and every employer 16 in the system. An exemplary mathematical function to compute the Euclidean distance may take the following form:

$$d ( p , q ) = \sqrt{( {p}_{1} - {q}_{1} ) \text{?} + {( {p}_{2} - {q}_{2} )}^{2} + … + ( {p}_{1} - \text{?} ) \text{?} + … + ( {p}_{2} - \text{?} ) \text{?}} . \\ \text{?} \text{indicates text missing or illegible when filed}$$

Where p₁ is the candidate response to the first candidate cultural question 26, q₁ is the employer response to the first employer cultural question 36, p₂ is the candidate response to the second candidate cultural question 26, q₂ is the employer response to the second employer cultural question 36, and so forth. The Matching Algorithm 44 may also be configured to adjust for the geographic distance between candidate 10 and employer 16 as reflected in their respective profiles 24, 34. That is to say, the Matching Algorithm 44 may be constructed so as to progressively discount a calculated Euclidean distance as a function of the geographic distance between candidate 10 and employer 16. The resulting Euclidean distance (which may or may not have been automatically adjusted for geographic distance) is stored and subsequently used by the Matching Algorithm 44 to provide matching results for candidates 10 and employers 16. Matches within a predefined distance calculation may be considered “super-matches.” The gap between the super-match distance and the maximum distance is then normalized to a percentage scale, also referred to as a correlation percentage value. The system establishes a predetermined match threshold, and considers normalized matches greater than or equal to the predetermined match threshold to be “pre-screened.” In FIGS. 3 and 5, the predetermined match threshold is suggested as 70% in query box 46, but of course this value can be adjusted up or down according to system administrator preference. It is also contemplated that the predetermined match threshold could be a variable that is set by either the employer 16 or by the candidate 10, or perhaps both.

In operation, the method and system of this invention are activated, typically, by a candidate 10 (from among the pool of candidates that have active candidate accounts 22), sending a search query from their candidate account 22 to the employer database 42. Alternatively, the search query can be initiated by the employer 16. See also description of the Search button 68, below. In either case, a search query is sent from a requesting party, where the requesting party is the candidate account in the first instance or the employer account in the second instance mentioned above. This initial, basic-level query may be very limited in nature/scope. For example, at this stage the search criteria may be selectable from a short-list of options. For a candidate 10 searching via their account 22, the short list of search options might include: industry type, company size, benefit preferences and geographic proximity. In other words, the candidate's initial search query is an attempt to find employers 16 within a certain industry, of a certain size range, offering a preferred scope of benefits, and that reside within a given geographic region. When the search is initiated by the employer 16, e.g., via their Search button 68, a different set of search criteria options—responsive to the needs of an employer—may be used. The employer 16 search option might for example include: department, position and travel distance, to name but a few. Although the system is configured to execute this search query, the raw, unfiltered results are not reported to the requesting party. That is to say, when the candidate account 22 is the requesting party, the candidate 10 is not able to see the full scope of employers 16 who match the basic-level search query. The reason the full search results are withheld is that some or all of the employers 16 that otherwise meet the candidate's initial search query would not provide a subjectively compatible workplace environment. To address this concern, the Matching Algorithm 44 is applied to the search results so as to compute the Euclidean distances between the candidate 10 and each employer 16 that met the basic-level search query, as described above. Only those employers 16 whose profiles 34 are greater than the predetermined match threshold are “pre-screened” and available to be shared with the candidate 16. As mentioned above, the predetermined match threshold could be set in the neighborhood of 70%.

When a candidate 10 is matched with an employer 16 in this manner, i.e., the match is “pre-screened,” the system enables the candidate 10 and the employer 16 to view all, or at least some basic, profile information about one another via their respective secure, password-protected accounts 22, 32. The candidate 10 cannot connect with an employer 16 through the system unless they have met or exceeded the matching threshold Likewise, the company can see the complete candidate profile, but they must request contact, which the candidate can refuse. The basic profile information available at this pre-screening stage may include the names and general addresses of the respective parties 10, 16, details about particular job postings, etc. The system is also configured to automatically send the candidate 10 the employer's set of pre-screening questions 40. The candidate 10 is invited to answer all of the pre-screening questions 40 via their secure, password-protected account 22, which answers are then directly transmitted to the employer 16 via their secure, password-protected account 32. In other to respect employer's need for recruiting efficiency, the system may be configured to withhold transmission when the candidate 10 does not answer all of the pre-screening questions, in which case the relationship will not advance. These initial activities serve as a preliminary vetting step to introduce the candidate 10 with each culturally-matched employer 16 that falls within their initial, basic-level query, and vice-versa. If the initial introductions are well-received on each side (i.e., both candidate 10 and employer 16 perceive value in advancing the relationship), the candidate 10 and employer 16 must enter into a mutual agreement to advance. A suitable agreement form is made available for electronic acknowledgement via the respective accounts 22, 32. Upon such mutual agreement, the candidate 10 is deemed “qualified” by the employer 16 and the system enables more detailed profile information sharing as well as opening a line of secure communication between the parties, which may include private chat style interactions 48.

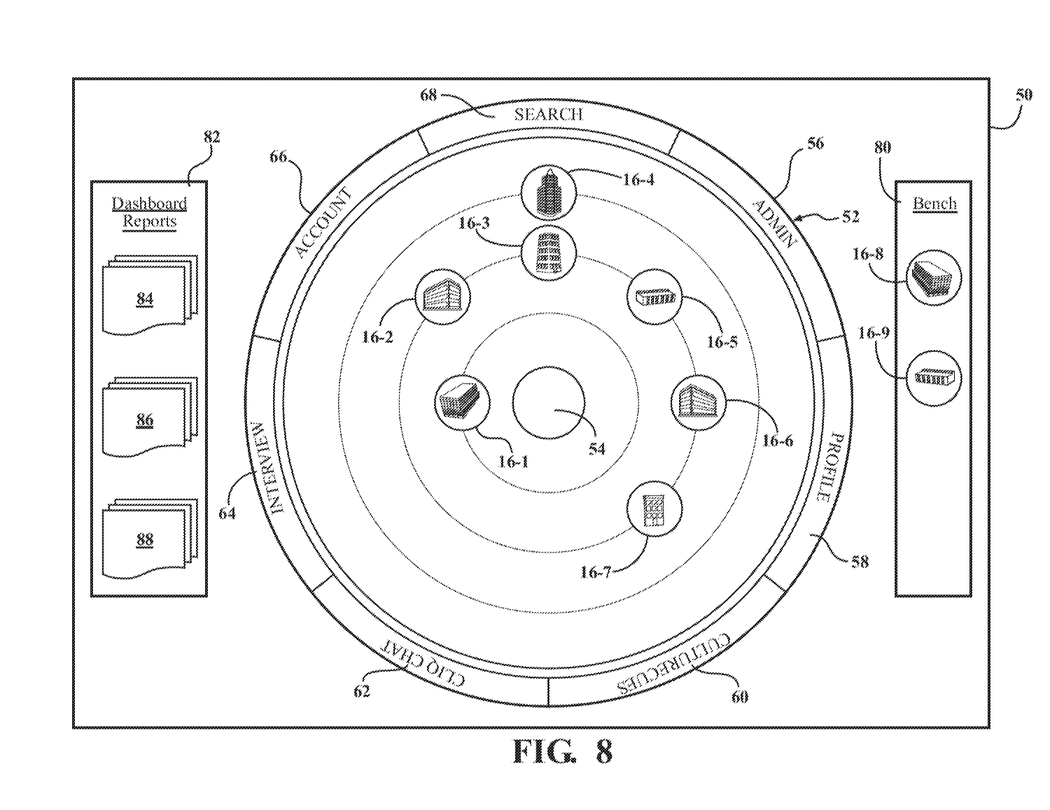

A graphic user interface 50, such as a computer monitor, used by the candidate 10 and by the employer 16, respectively, to view their own account 22, 32 when accessed on-line. FIG. 8 portrays an exemplary display graphic of a matched result appearing on the graphic user interface 50, respectively, to the candidate 10 and to the employer 16. The matched result is conveniently portrayed in a visually convenient form composed of the matched potential leads for each party. The visual presentation can take many different forms; those forms described and illustrated herein are preferred examples but it is contemplated that different expressions of the relevant information are certainly possible. In the illustrated embodiment, the visual presentation includes iconic representations of the “pre-screened” and “qualified” matched entities strategically placed on an annular radar diagram 52 having a geometric center 54. I.e., in the illustrated examples, the filtered, matched results 52 are shown in the style of a radar diagram 52. The radar diagram 52 will be substantially similar for both candidates 10 and employers 16. In the illustrated example, the radar diagram 52 appears on the graphic user interface 50 when accessed through candidate account 22. Iconic representations 16-1, 16-2 . . . 16-9 correspond with the collection of “pre-screened” and “qualified” employers 16. In the case of an employer account 32 (not shown), the radar diagram 52 would present iconic representations of “pre-screened” and “qualified” candidates 10 in a similar fashion.

Optionally, the visual presentation of search results may be further enhanced to include a customized watch list, which is shown in FIG. 8 as bench area 80. The bench area 80 is a designated region on the display screen 50 into which a user (10 or 16) can group the most interesting matches relating to cultural fit. To move interesting matches into the bench area 80, the user actuates some form of an interactive pointer through a mouse, touchpad, stylus pen, or any other suitable interface, to relocate the desired match result icon(s) from the radar screen 52 and into the bench area 80. In FIG. 8, the user (a candidate in this example) has moved two most interesting match results 16-8 and 16-9 into the bench area 80. Of course, when the user is the employer 16, the bench area 80 will be used to set apart particularly interesting prospective candidates. When the match results return large numbers of matches, the user may take advantage of this watch list feature to improve efficiency and organization of information that is provided to them by the system and method of this invention. Alternatively, other techniques may be used to set apart or otherwise identify the most interesting matches. Alternative examples might include a feature that allows the user to change the shape or scale of the most interesting the iconic representations. Another example might be to permit a user to apply different colors to the iconic representations—such as green for most interesting, yellow for a secondary tier of interesting the iconic representations, and red for a tertiary interest level. Many variations are of course possible.

In yet another optional configuration, the visual presentation may include a dashboard reports area 82, as shown in FIG. 8. The dashboard reports area 82 is a designated region on the display screen 50 in which useful reports and data are accessed by the user (10 or 16). Exemplary reports found within the dashboard reports area 82 may include: Total Profile Views 82, and Profile Views Today 84. A generic reports icon 86 is shown also in the dashboard reports area 82 to signify that any additional, useful reports may be provided to assist the candidate 10 and employer 16 in efficiently and effectively utilizing the full functionality of the system and methods of this invention. The system may be configurable by the user to choose the type and arrangement of reports 82-86 within the dashboard area 82

A candidate 10 or employer 16 accesses this radar diagram 52 through their respective secure account 22, 32 to see “who is on their radar.” The calculated match rate, i.e., the correlation percentage value, determines how close to the center 54 of the radar diagram 52 a particular icon appears. Returning the specific example of FIG. 8 which corresponds to a candidate account 22, employers 16 with a near 100% match rate may appear as an icon representation at the center 54 of the radar diagram 52. The radar diagram 54 is configured with a plurality of distance rings. Each ring theoretically represents a different range in the match rate (i.e., correlation percentage value) between the candidate 10 and the employer 16. In one example, the ring closest to the center 56 contains the above-noted “super-matches.” The next larger ring represents match rates in the 90-99%. And the ring after that the 80-89% range. And the outermost ring the 70-79% range. Of course, these are merely exemplary range values suggested for illustrative purposes. Accommodations can easily be made for situations when more matches exist at a particular range than can be comfortably contained within any given ring (especially for the smaller inner-most rings). As some possible solutions to this over-crowding issue, the ring ranges can be dynamically adjusted or some matches can be forced to spill over into subsequent rings. It is considered important that the user (be it candidate 10 or employer 16) always be able to see the highest level of matches, yet also continue to see them in relative distance to one another. In this manner, the user can quickly access the profiles of matching entities, complete pre-screening steps, and engage in secure communications, etc., by clicking the icon appearing on their radar diagram 52.

In the exemplary embodiment illustrated in FIG. 8, the radar diagram 52 is circumferentially surrounded by a plurality of actuator buttons 56-68. Each actuator button corresponds to a different action or function available to the user within their secure account 22, 32. The exemplary actuator buttons include an Administrative button 56, a Profile button 58, a Culturecues (culture descriptors) button 60, a Chat button 62, an Interview button 64, an Account button 66 and a Search button 68. Other actuator buttons and options are certainly possible. Of those listed, the Administrative button 56 would not normally be visible or available to ordinary users of the system. The Administrative button 56 would, however, be a feature used by the system administrator of the present invention to manage the computer environment, set variables, delete user accounts 22, 32, and attend to other duties required by the proper management and administration of the present invention. The Profile button 58 allows the user (be it candidate 10 or employer 16) to update their profile 24, 34. The Culturecues (culture descriptors) button 60 allows the user to update their responses to the culture questions 26, 36. The Chat button 62 allows the user to engage in secure communications, such as email, chat, video-conference, etc. with qualified other parties (which may also include other affinity group members as described below). Then Interview button 64 contains the list of pre-screening questions mentioned above. When the Interview button 64 is accessed through an employer account 32, the employer 16 is able to edit their list of a pre-screening questions that they want to have answered when a candidate 10 submits their profile 24 and/or otherwise is “pre-screened.” The Account button 66 allows the user to set-up and edit their account details, including billing information and the like. The Search button 68 allows the user (candidate 10 or employer 16) to execute the initial, basic-level search query described above. When the Search button 68 is accessed through an employer account 32, the search allows them to find candidates in the system based on the textual descriptions appearing in the database collection of candidate profiles 24. As described above, however, the raw search results are filtered (by the Matching Algorithm 44) based on the user-specified matching criteria, i.e., based on the filter settings they have chosen. Other actuator buttons and options are certainly possible.

Returning to FIGS. 1 and 2, another novel aspect of the present invention will now be described. The method and system of this invention preferably includes an affinity group database 70 and an affinity group server 72. In previous descriptions, the Matching Algorithm 44 was said to, in effect, filter the raw search query results from either a candidate 10 or user 16 (via the Search button 68). In another capacity, the Matching Algorithm 44 is responsive to commands from the affinity group server 72 to query all profiles 24 in the candidate database 30 and all profiles 34 in the employer database 42 in search of generalized affinity matches. Affinity group matches are stored in the affinity group database 70. Affinity matches are not limited to candidate-to-employer, but can be found in candidate-to-candidate and employer-to-employer situations where there is a sufficiently close Euclidean distance found between any two profiles 24, 34.

Users of like-minded cultural preferences are assigned into a common affinity group 74, which information is stored in the affinity group database 70. In FIG. 1, for example, affinity group 74-A has been formed with candidates 10, 12, 14 and employers 16, 18, 20 all being associated therewith on the basis of a sufficiently strong enough cultural similarity (as determined by comparison of the responses to the respective cultural questions 26, 36). Continuing in this same example, affinity group 74-B has been formed with candidate 10 and employers 16, 18 to represent an affinity group that is more densely populated by employers but nevertheless includes some candidates. Affinity group 74-C has been formed with candidates 12, 14 and employer 20 to represent an affinity group that is more densely populated by candidates but may nevertheless include some employers. Affinity group 74-D represents an affinity group that is composed entirely of candidates 10, 12, 14. And affinity group 74-E represents an affinity group that is composed entirely of employers 16, 18, 20.

Once a user account 22, 32 is associated with an affinity group in the affinity group server 70, that user (be it candidate 10 or employer 16) is able to see other member accounts within the same affinity group. Preferably, all of the user accounts 22, 32 associated with a common affinity group can view basic profile information about one another, such as names and general addresses and social media accounts, etc. In the example of affinity group 74-A (FIG. 1), all of the candidates 10, 12, 14 and all of the employers 16, 18, 20 can view these basic detail about one another even if they do not have any realistic prospect of common employment. The system also enables these user accounts 22, 32 associated with a common affinity group 74 to securely communicate within the group, such as via bulletin boards, forums, chats, video-conferences, and the like.

The system administrator, acting through the affinity group server 72, may choose to descriptively name each affinity group 74 based on the common character traits of its members. It is contemplated that the system will automatically generate affinity groups 74 for each unique permutation of responses available in the candidate 30 and employer 42 databases. Alternatively, the system may permit users to create (or request through the system administrator) custom affinity groups 74 that factor select qualitative data included in the user profiles 24, 34 such as geographic location, industry association, etc. Such custom affinity groups 74 can be understood as “sub-groups” in that they are likely to exist in broader context already in the affinity group database 70. The affinity groups 74 can be very useful tools to assist in networking efforts between and among all users of the system.

In summary, the present invention is a web-based matching system, i.e., a form of meeting place, for potential candidates 10 to be matched with employers 16 based in significant part on the nature of the employer's culture and the working environment a candidate 10 seeks. The system's computer environment manages candidate 30 and employer 42 databases, in which information is respectively stored by the candidate 22 and employer 32 accounts. Based upon initial searching queries by candidates 10 and/or employers 16, the system generates matched results that appear on private candidate and employer account screens 50, preferably in the form of a radar diagram 52.

In order to generate quality matches, the system relies heavily on a specially defined set of cultural descriptors (i.e., cues). The cultural descriptors expose the working characteristics of candidates 10 and the working environments of employers 16. The novel Matching Algorithm 44 connects those of similar cultural preferences. While completing respective profiles 24, 34, the potential candidates 10 and the participating employers 16 each record answers to the defined set of cultural questions 26, 36 (an exemplary list is set forth above). The answers are placed on a weighted scale which is mathematically analyzed to indicate the culture of an offered/desired workplace environment. It is to be understood that the cultural descriptors are not an “assessment” per se of the potential candidates 10 or employers 16. Rather, the cultural descriptors indicate the propensity of the potential candidate 10 or employer 16 to identify cultural characteristics that are important to them, as measured on the weighted scale system mentioned above. The profiles 24, 34 also include qualitative information such as geographic location and benefit structure desires/offerings, etc.

All information about potential candidates' profiles 24 and employers' profiles 34 are stored and managed in respective candidate and employer databases 30, 42. The Matching Algorithm 44 accesses both candidate 30 and employer 42 databases. As a candidate 10 searches the employer database 42 for a prospective employer 16 based on factors such as industry type, company size, benefit preferences and geographic proximity, the Matching Algorithm 44 compares the candidate's profile 24 to the profiles 34 of the employers 16 who meet the candidate's search criteria. This profile comparison calculates a match rate as a function of the numerical weights associated with the scale values ascribed to the respective candidate cultural descriptors and the employer cultural descriptors. A match rate threshold is established, which in one embodiment is set at 70%. When the calculated match rate exceeds the threshold (i.e., when the cultural descriptors match is at least 70% between candidate 10 and employer 16), the Matching Algorithm 44 presents the filtered match data through a unique annular radar diagram 52. Users 10, 16 access the system to see “who is on their radar.” The calculated match rate determines how close to the center 54 of the radar diagram 52 a particular matching entity appears. Entities with a 100% match rate may appear as “super-match” icon representations at the center 54 of the radar diagram 54. The lower the calculated match rate, the further from the center 54 the iconic representation will appear. Calculated match rates below the threshold will not be visible on the radar diagram 52.

Matching data presented on the radar diagram 52 enables certain initial activities to be carried out between the candidate 10 and each matching employer 16. These limited initial activities may include: the ability for the candidate 10 and the employer 16 to view basic profile information about one another, details about particular job postings and automatically sending the candidate 10 a set of pre-screening questions. The pre-screening questions are pre-defined by the employer 16 in its profile 34. These initial activities serve as a preliminary vetting step to introduce the candidate 10 with the culturally-matched employer 16. The candidate 10 and employer 16 must enter into a mutual agreement to advance their relationship, whereupon the candidate 10 is deemed “qualified” by the employer 16 and the system enables more detailed profile information sharing as well as opens a line of secure communication between the parties.

The system is particularly efficient for employers 16 seeking to recruit talent by presenting them with “qualified” candidate 10 leads who are matched with the employer's culture, matched with the employer's benefit structure, matched with the employer's geographical proximity, matched with the employer's specific job needs, who have been described in a standardized proprietary profile 24, and who have responded to the employer-defined pre-screening questions.

Furthermore, the system automatically generates affinity groups 74 based on the unique answer combinations to the cultural questions 26, 36. Both candidates 10 and employers 16 are placed in sufficiently matching affinity groups 74. Affinity groups 74 can be composed candidates 10 and/or employers 16, and are intended to facilitate the networking of like-minded people for both professional and recreational purposes. An unlimited number of affinity groups 74 may be formed, either automatically by the system or initiated by users looking to form a custom group based on a particular set of attributes.

The system includes an optional social network aspect. The social network aspect leverages a connection to the candidate 10 and employer 16 pre-existing social media accounts 28, 38. Information contained in the social media account 28, 38 is made readily accessible through the system and included in the profile data 24, 34 for consideration by others after a sufficiently high match rate is calculated (i.e., for “pre-screened” candidates 10) and/or by other members of a common affinity group 74.

The system can be modified to incorporate additional searching and/or filtering capabilities for job matching and other purposes. As an example, a job traits matching system can be configured to take advantage of the algorithm used to produce the radar diagram 52. The job traits matching system could capitalize on the attributes data collected about what an employer 16 considers needed for a particular job, and the self-described attributes of the candidates 10. The employer 16 simply selects from a list of attributes they would like to see a job candidate 10 possess, and the candidate 10 selects from the same list indicating their attributes. Then a match is made by the system. The watch list enabled by the bench 80 can also be utilized in connection with these job matching purposes.

The foregoing invention has been described in accordance with the relevant legal standards, thus the description is exemplary rather than limiting in nature. Variations and modifications to the disclosed embodiment may become apparent to those skilled in the art and fall within the scope of the invention. Furthermore, particular features of one embodiment can replace corresponding features in another embodiment or can supplement other embodiments unless otherwise indicated by the drawings or this specification.

What is claimed is:

1. A computer-assisted method for connecting candidates and employers, said method comprising the steps of:
establishing a candidate account associated with a candidate, the candidate account having an electronic candidate profile, adding candidate qualitative data and candidate cultural data to the electronic candidate profile, said step of adding candidate cultural data to the candidate profile including recording answers to a defined set of candidate cultural questions, said step of recording answers to a defined set of candidate cultural questions including ascribing a scale value to each of a plurality of candidate cultural descriptors,
submitting the completed candidate profile to a candidate database, the candidate database including a computer readable storage medium configured to electronically store the candidate profile data,
establishing an employer account associated with an employer, the employer account having an electronic employer profile, adding employer qualitative data and employer cultural data to the electronic employer profile, said step of adding employer cultural data to the employer profile including recording answers to a defined set of employer cultural questions, said step of recording answers to a defined set of employer cultural questions including ascribing a scale value to each of a plurality of employer cultural descriptors,
submitting the completed employer profile to an employer database, the employer database including a computer readable storage medium configured to electronically store the employer profile data,
sending a search query from a requesting party, the requesting party comprising either the candidate account sending the search query to the employer database or the employer account sending the search query to the candidate database, generating but not displaying to the requesting party the search results in response to the search query, applying a Matching Algorithm to the search results wherein the Matching Algorithm is operatively connected to the candidate database and the employer database, said step of applying a Matching Algorithm including calculating a match rate as a function of the numerical weights associated with the scale values ascribed to the respective candidate cultural descriptors and the employer cultural descriptors, and displaying the match rate produced by the Matching Algorithm through a graphic user interface to the account of the requesting party when the match rate exceeds a predetermined threshold value.

2. The method of claim 1 wherein both the candidate cultural descriptors and the employer cultural descriptors are selected from the same group consisting essentially of: Learning Environment and Laid-Back and Creative and Rewarding and Global and Results Driven and Collaborative and Technical and Academic and Competent and Community Focused and Individualistic and Social and Hip and Engaged and Team Oriented and Work Life Balance and Accountable and Empowered and Cautious and Innovative and Professional and Flexible and Positive and Risk Taking and Wellness Oriented and Growth Oriented and Travel Free and Challenging and Bold.

3. The method of claim 1 wherein said scale value is selected from a group consisting essentially of: Not Important and Not Necessary and Neutral and Important and Necessary, associating a numerical weight to said scale value in ascending relation wherein Not Important is the lowest and Not Necessary is the second lowest and Neutral is the third lowest and Important is the second highest and Necessary is the highest.

4. The method of claim 1 wherein said calculating step includes determining the Euclidean distance in n-dimensional space between the candidate cultural descriptors and the employer cultural descriptors.

5. The method of claim 1 further including the step of providing an affinity group server, associating the candidate account with at least one affinity group in the affinity group server based on the scale values ascribed to each of the candidate cultural descriptors, associating the employer account with at least one affinity group in the affinity group server based on scale values ascribed to each of the employer cultural descriptors.

6. The method of claim 5 further including the steps of revealing to the candidate account details about other member accounts within the affinity group, and revealing to the employer account details about other member accounts within the affinity group.

7. The method of claim 5 further including the step of providing an electronic bulletin board among the member accounts within the affinity group via the affinity group server.

8. The method of claim 1 further including the step of enabling secure communication between the candidate and the employer upon mutual agreement between the candidate and the employer.

9. The method of claim 8 wherein said step of enabling secure communication includes providing an interactive chat forum.

10. The method of claim 1 wherein said step of displaying the match rate includes locating an iconic representation of the matched entity within an annular radar diagram having a geometric center.

11. The method of claim 10 wherein the proximity of the iconic representation to the geometric center is a function of the calculated match rate.

12. The method of claim 1 wherein said step of generating but not displaying to the candidate account search results in response to the search query includes determining the geographic distance between the geographic location data in the electronic candidate profile and the geographic location data in the electronic employer profile.

13. The method of claim 1 further including the step of automatically sending a plurality of prescreening questions to the candidate account when the correlation percentage value is greater than or equal to the predetermined match threshold value.

14. The method of claim 1 further including the step of automatically sending at least a portion of the employer profile to the candidate account when the correlation percentage value exceeds the predetermined match threshold value, and automatically sending at least a portion of the candidate profile to the employer account when the correlation percentage value exceeds the predetermined match threshold value.

15. The method of claim 1 wherein said step of adding candidate qualitative data to the candidate profile includes recording personal contact information and geographic location data and aptitude examples and working experience examples and personal social media account information and personal reference information and benefit structure and industry and size of company and position into the electronic candidate profile.

16. The method of claim 1 wherein said step of adding employer qualitative data to the employer profile includes recording business contact information and geographic location data and benefit structure and department and position into the electronic employer profile.

17. The method of claim 1 further including the step of associating a social media account with at least one of the candidate profile and the employer profile.

18. A computer-assisted method for connecting candidates and employers, said method comprising the steps of:
establishing a candidate account associated with a candidate, the candidate account having an electronic candidate profile, adding candidate qualitative data and candidate cultural data to the electronic candidate profile, said step of adding candidate qualitative data to the candidate profile including recording at least personal contact information and geographic location data into the electronic candidate profile, said step of adding candidate cultural data to the candidate profile including recording answers to a defined set of candidate cultural questions, said step of recording answers to a defined set of candidate cultural questions including ascribing a scale value to each of a plurality of candidate cultural descriptors,
submitting the completed candidate profile to a candidate database, the candidate database including a computer readable storage medium configured to electronically store the candidate profile data,
establishing an employer account associated with an employer, the employer account having an electronic employer profile, adding employer qualitative data and employer cultural data to the electronic employer profile, said step of adding employer qualitative data to the employer profile including recording at least business contact information and geographic location data into the electronic employer profile, said step of adding employer cultural data to the employer profile including recording answers to a defined set of employer cultural questions, said step of recording answers to a defined set of employer cultural questions including ascribing a scale value to each of a plurality of employer cultural descriptors,
submitting the completed employer profile to an employer database, the employer database including a computer readable storage medium configured to electronically store the employer profile data,
sending a search query from the candidate account to the employer database, said step of sending a search query including at least search criteria of industry type and geographic proximity and size of company, generating but not displaying to the candidate account search results in response to the search query, applying a Matching Algorithm to the search results wherein the Matching Algorithm is operatively connected to the candidate database and the employer database, said step of applying a Matching Algorithm including calculating a match rate as a function of the numerical weights associated with the scale values ascribed to the respective candidate cultural descriptors and the employer cultural descriptors, said calculating step including determining the Euclidean distance in n-dimensional space between the candidate cultural descriptors and the employer cultural descriptors, displaying the match rate produced by the Matching Algorithm through a graphic user interface to the candidate account and the employer account when the match rate exceeds a predetermined threshold value, sending at least a portion of the employer profile to the candidate account when the match rate exceeds a predetermined threshold value, sending at least a portion of the candidate profile to the employer account when the match rate exceeds a predetermined threshold value, and sending the candidate a plurality of prescreening questions when the match rate exceeds a predetermined threshold value.

19. The method of claim 18, wherein said step of displaying the match rate includes locating an iconic representation of the matched entity on an annular radar diagram having a geometric center, wherein the proximity of the iconic representation to the geometric center is a function of the numerically-calculated match rate value.

20. The method of claim 18, further including the step of providing an affinity group server, associating the candidate account with at least one affinity group in the affinity group server based on the scale values ascribed to each of the candidate cultural descriptors, associating the employer account with at least one affinity group in the affinity group server based on scale values ascribed to each of the employer cultural descriptors, revealing to the candidate account other member accounts within the affinity group, revealing to the employer account other member accounts within the affinity group, enabling secure communication among the member accounts within each affinity group via the affinity group server, said step of enabling secure communication including providing an electronic bulletin board, said step of enabling secure communication including providing an interactive chat forum.
